(19) United States
(12) Patent Application Publication
(10) Pub. No.: US 2006/0197369 A1
(43) Pub. Date: Sep. 7, 2006

(54) Rim structure of a bicycle

(76) Inventors: Chang-Hsuan Chiu, Daya Township (TW); Ming-Te Lin, Gueishan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/268,455

(22) Filed: Nov. 8, 2005

(30) Foreign Application Priority Data
Mar. 3, 2005 (CN) 094203280

(51) Int. Cl. B60B 21/12

(52) U.S. Cl. 301/6.3; 301/95.102

(57) ABSTRACT

A rim structure of a bicycle, including a main body 1 having two annular sidewalls 11-12 and an annular rib 13 connected between the sidewalls. Outer ends of the sidewalls distal 11-12 from the circular center of the rim and the rib 13 together define a chucking groove 14 for chucking a tire 2 therein. The main body 1 is completely made of composite material. Multiple heat-radiating blocks 15 are inlaid in portions of the sidewalls in contact with the brake blocks 3 and arranged at intervals. The heat-radiating blocks 15 are made of high heat-radiation efficiency materials. The main body 1 and the heat-radiating block 15 have different frictional coefficients. The heat-radiating blocks are capable of quickly dissipating the heat generated due to friction between brake blocks 15 and the sidewalls 11-12 of the rim. In addition, due to the different frictional coefficients, an antilock/antiskid effect is achieved.

### BACKGROUND OF THE INVENTION

The present invention is related to a composite material-made rim structure of a bicycle, and more particularly to a composite material-made rim structure capable of quickly dissipating the heat and having antilock/antiskid function.

The conventional bicycle rims are mostly made of metal materials. The metal materials have heavier weight. For achieving lightweight rim, recently various composite material-made rim structures have been developed.

FIGS. 5 and 6 show a conventional aluminum alloy rim 5. Each side of the rim 5 is formed with several arced grooves 51 with a certain depth. The arced grooves 51 are arranged along the rim 5 at intervals. A carbon fiber material 52 is inlaid in each groove 51 to reduce the total weight of the aluminum alloy rim. However, such rim structure is still mainly made of aluminum alloy and thus the weight of such aluminum alloy rim is still heavier than the weight of carbon fiber-made rim.

The rim made of all-carbon fiber material is advantageous over the conventional metal-made rim in lightweight. However, the ordinary carbon fiber reinforced polymer composite materials are not heat-resistant. Under a temperature over 200° C., the strength of the carbon fiber reinforced polymer composite material will be deteriorated. Moreover, the surface of the carbon fiber reinforced polymer composite material will be damaged due to high temperature. Besides, the rim made of all-carbon fiber reinforced polymer composite materials has lower heat-radiation coefficient. Therefore, the instantaneous frictional temperature of the portions of the rim in contact with the brake blocks is up to 350° C. In other words, the portions of the all-carbon fiber material-made rim in contact with the brake blocks will be abnormally worn out due to high working temperature. In order to increase the heat resistance of the all-carbon fiber material-made rim, it is necessary to manufacture the rim with high heat-resistant resin material. However, the unit price of such resin material is high and the manufacturing cost is increased.

In order to solve the above problems, a rim structure made of composite material has been developed. The composite material is composed of aluminum material and carbon fiber wrapping the aluminum material. Alternatively, the composite material is composed of aluminum ring and carbon fiber bonded with the aluminum ring. The aluminum material or aluminum ring has a heat-radiating effect better than that of carbon fiber so that the abnormal wear caused by overheating of the rim can be avoided. However, the metal parts of the above rim structures still somewhat lead to the problem of heavy weight. Therefore, it is necessary to provide an improved rim structure for overcoming all the above problems.

### SUMMARY OF THE INVENTION

It is therefore a primary object of the present invention to provide a rim structure of a bicycle. The main body of the rim structure is made of composite material. Multiple heat-radiating blocks are inlaid in the portions of the sidewalls of the rim in contact with the brake blocks and arranged at intervals. The heat-radiating blocks are made of high heat-radiation efficiency material for quickly dissipating the heat generated due to friction between brake blocks and the sidewalls of the rim. The rim structure can achieve both effects of lightweight and high heat-radiation efficiency.

According to the above object, the rim structure of the bicycle of the present invention includes a main body having two annular sidewalls and an annular rib connected between the sidewalls. Inner ends of the sidewalls proximal to a circular center of the rim are connected with each other. Outer ends of the sidewalls and the rib together define a chucking groove for chucking a tire therein. The main body is completely made of composite material and multiple heat-radiating blocks are inlaid in the sidewalls at intervals. The heat-radiating blocks are made of high heat-radiation efficiency materials, whereby the heat-radiating blocks can quickly dissipate the heat generated due to friction between brake blocks of the bicycle and the sidewalls of the rim.

The present invention can be best understood through the following description and accompanying drawings wherein:

### BRIEF DESCRIPTION OF THE DRAWINGS

FIG. 1 is a perspective exploded view of a part of the rim structure of the present invention;

FIG. 2 is a sectional view showing the arrangements of the rim structure of the present invention and the tire and brake blocks of a bicycle;

FIG. 3 is a sectional view showing that the heat-radiating block of the present invention is inlaid in the inlay dent of the sidewall of the rim structure; and

FIG. 4 is a sectional view of a second embodiment of the present invention, showing that the heat-radiating block is inlaid in the inlay dent of the sidewall of the rim structure.

FIG. 5 is a partially sectional view of a conventional aluminum alloy rim in which carbon fiber materials are inlaid; and

FIG. 6 is a side view of the conventional aluminum alloy rim in which carbon fiber materials are inlaid.

### DETAILED DESCRIPTION OF THE PREFERRED EMBODIMENTS

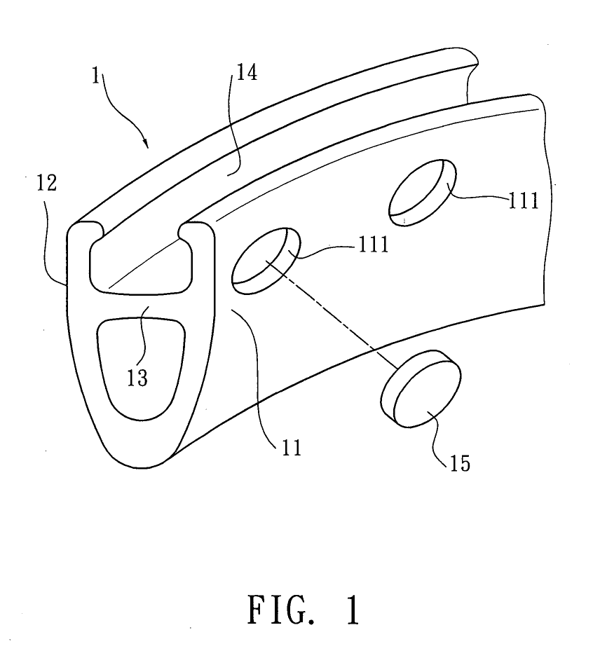

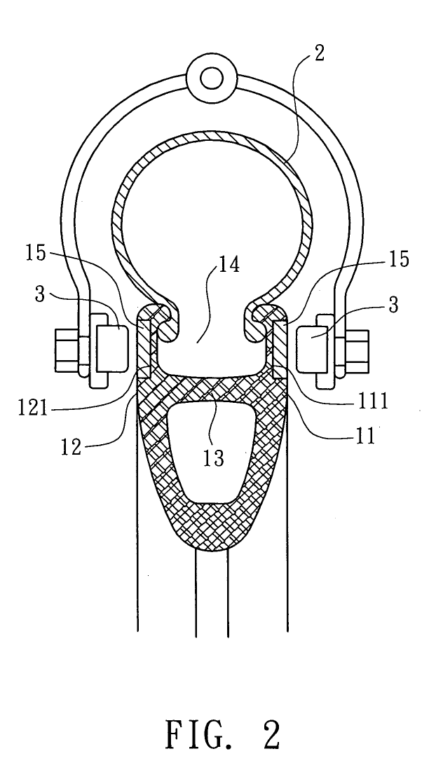

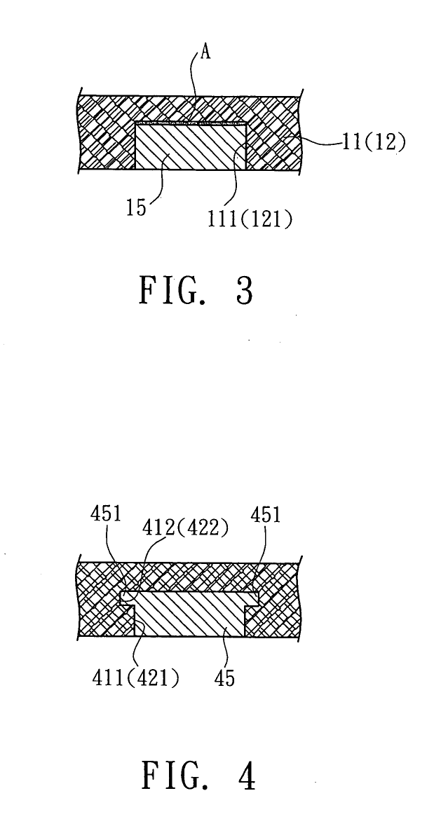

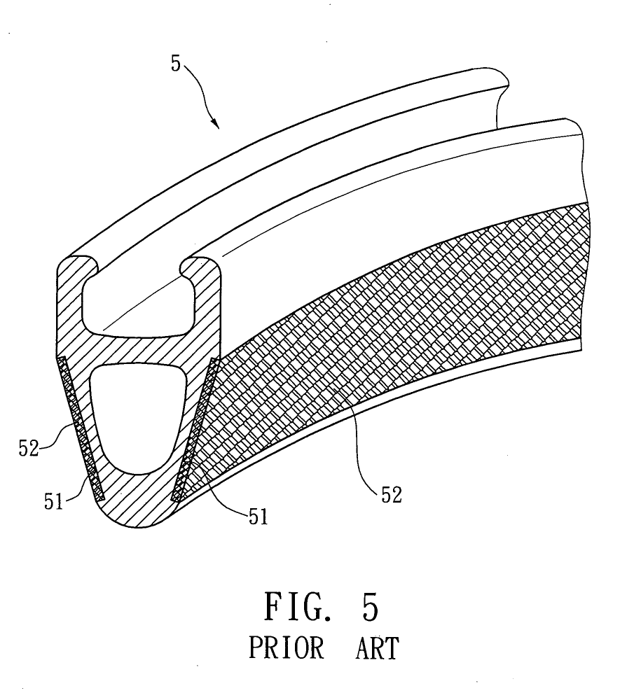

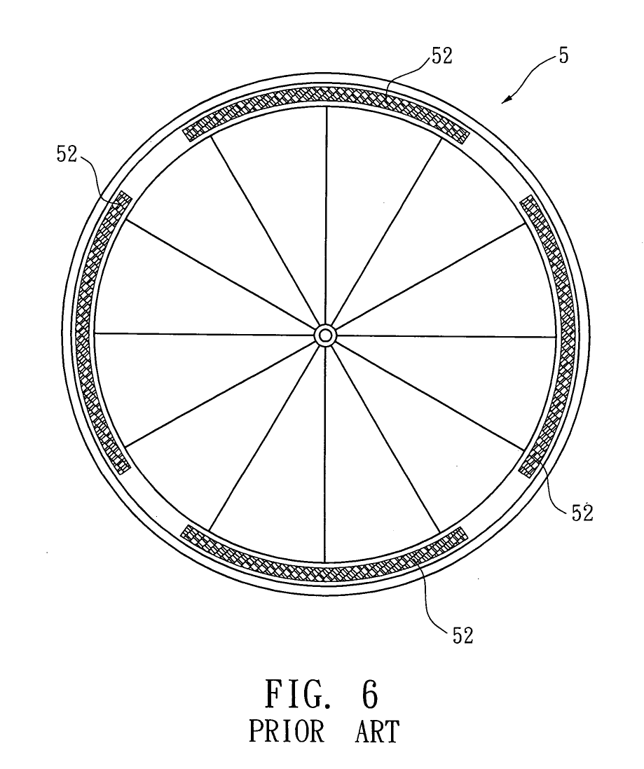

Please refer to FIGS. 1 to 3. The rim structure of a bicycle of the present invention includes a main body 1 made of one of all-carbon fiber, fiberglass and Aramid fiber or a composite material thereof. The main body 1 has two annular sidewalls 11, 12. An annular rib 13 is connected between the sidewalls 11, 12. In addition, inner ends of the sidewalls 11, 12 proximal to the circular center of the rim are connected with each other. Outer ends of the sidewalls 11, 12 and the rib 13 together define a chucking groove 14 in which a tire 2 is chucked.

The main body 1 is completely made of composite material. In this embodiment, the main body 1 is made of all-carbon fiber. The sidewalls 11, 12 are respectively formed with two annular braking sections corresponding to the brake blocks 3. Multiple inlay dents 111, 121 are arranged on the annular braking sections at intervals. A heat-radiating block 15 is inlaid in each inlay dent 111, 121. The heat-radiating block 15 is made of one of carbon/carbon composite material, copper, aluminum alloy and graphite. The heat-radiating block 15 has a shape adapted to the shape of the inlay dent 111, 121, whereby the heat-radiating block 15 can be inlaid and fixedly adhered in the inlay dent 111, 121 with a high-performance adhesive A. The heat-radiating block 15 is flush with the outer surface of the sidewalls 11, 12 to form a smooth face.

With the heat-radiating block 15 made carbon/carbon composite material exemplified, the heat capacity of the carbon/carbon composite material is 2.5 times the heat capacity of a general metal material. Moreover, the carbon/carbon composite material is characterized in that the strength and rigidity of the carbon/carbon composite material keep unchanged under condition of 2500° C. high temperature. Therefore, the heat-radiating blocks 15 inlaid in the main body 1 of the rim structure can quickly dissipate the heat generated due to friction between the brake blocks 3 and the sidewalls 11, 12 of the rim. Accordingly, the rim main body 1 made of all-carbon fiber reinforced polymer composite material will not be abnormally worn due to overheating. In addition, the heat-radiating blocks 15 enhance the braking effect. This is because that the main body and the heat-radiating block are made of different materials and have different frictional coefficients. Therefore, when braked, an intermittent braking effect is achieved as an ABS brake system. Therefore, the braking distance can be shortened and an antilock/antiskid effect is achieved. Furthermore, the rim main body 1 made of all-carbon fiber reinforced polymer composite material and the heat-radiating blocks 15 made of carbon/carbon composite material are both lightweight materials. Therefore, the present invention can achieve both effects of lightweight and high heat-radiation efficiency as well as antilock/antiskid function.

FIG. 4 shows a second embodiment of the present invention, in which the heat-radiating block 45 has several tenons 451 projecting from outer circumference of the heat-radiating block 45. The inlay dent 411, 421 is formed with several mortises 412, 422 corresponding to the tenons 451. By means of inserting the tenons 451 into the mortises 412, 422, the heat-radiating block 45 can be fixed in the inlay dent 411, 421. This can achieve the same effect as the first embodiment.

In order to prevent the heat-radiating blocks from conducting the frictional heat to the main body, a heat-insulating layer can be laid between each heat-radiating block and the walls of the inlay dent. The heat-insulating layer can be made of fiberglass or aramid fiber.

The above embodiments are only used to illustrate the present invention, not intended to limit the scope thereof. Many modifications of the above embodiments can be made without departing from the spirit of the present invention.

What is claimed is:

1. A rim structure of a bicycle, comprising a composite material-made main body 1 having two annular sidewalls 11-12 and an annular rib 13 connected between the sidewalls 11-12, inner ends of the sidewalls proximal to a circular center of the rim being connected with each other, outer ends of the sidewalls and the rib together defining a chucking groove 14 for chucking a tire 2 therein, said rim structure being characterized in that the main body 1 is completely made of composite material and the sidewalls are respectively formed with two annular braking sections, at least one inlay dent 111 (112) being arranged on each annular braking section, the heat-radiating blocks 15 being made of high heat-radiation efficiency material, whereby the heat-radiating blocks 15 can quickly dissipate the heat generated due to friction between brake blocks 3 of the bicycle and the sidewalls 11-12 of the rim and achieve antilock/antiskid effect.

2. The rim structure of the bicycle as claimed in claim 1, wherein the heat-radiating blocks 15 are made of one of carbon/carbon composite material, copper, aluminum alloy and/or graphite.

3. The rim structure of the bicycle as claimed in claim 1, wherein the main body 1 is made of one of all-carbon fiber, fiber glass and Aramid fiber or a composite material thereof.

4. The rim structure of the bicycle as claimed in claim 3, wherein the annular braking sections of the sidewalls are formed with multiple inlay dents 111-121 arranged at intervals, the heat-radiating blocks 15 having a shape adapted to a shape of the in lay dents, where by multiple heat-radiating blocks can be inlaid in the inlay dents in flush with outer surfaces of the sidewalls to form smooth faces.

5. The rim structure of the bicycle as claimed in claim 4, wherein the heat-radiating blocks are inlaid and fixedly adhered in the inlay dents with a high-performance adhesive.

6. The rim structure of the bicycle as claimed in claim 4, wherein a heat-insulating layer is laid between each heat-radiating block and the walls of the inlay dent 111-121 for preventing the heat-radiating block from conducting the heat to the main body.

7. The rim structure of the bicycle as claimed in claim 6, wherein the heat-insulating layer is made of fiberglass or aromatic fiber.

8. The rim structure of the bicycle as claimed in claim 4, wherein each heat-radiating block has several tenons 451 projecting from outer circumference of the heat-radiating block, each inlay dent being formed with several mortises 412-422 respectively corresponding to the tenons 451, whereby by means of inserting the tenons into the mortises, the heat-radiating block 15 can be fixed in the inlay dent 111-121.

9. The rim structure of the bicycle as claimed in claim 8, wherein a heat-insulating layer is laid between each heat-radiating block and the walls of the inlay dent for preventing the heat-radiating block from conducting the heat to the main body.

10. The rim structure of the bicycle as claimed in claim 9, wherein the heat-insulating layer is made of fiberglass or aromatic fiber.
